(19) United States
(12) Patent Application Publication
(10) Pub. No.: US 2022/0405843 A1
(43) Pub. Date: Dec. 22, 2022

(54) GRAPHICAL USER INTERFACE FOR ORDER TRANSMISSION

(71) Applicant: BGC PARTNERS, L.P., NEW YORK, NY (US)

(72) Inventors: Howard W. Lutnick, New York, NY (US); Antonio Mercardo, New York, NY (US)

(21) Appl. No.: 17/893,280

(22) Filed: Aug. 23, 2022

Related U.S. Application Data
(63) Continuation of application No. 15/867,325, filed on Jan. 10, 2018.
(60) Provisional application No. 62/444,711, filed on Jan. 10, 2017.

(51) Int. Cl. G06Q 40/04; G06F 3/04817; G06F 3/0482; G06Q 30/08

(52) U.S. Cl. CPC G06Q 40/04; G06F 3/04817; G06F 3/0482; G06Q 30/08

(57) ABSTRACT

Disclosed herein are an apparatus, method, and non-transitory computer readable medium that renders a graphical user interface for order entry. A graphical user interface is rendered and an actuation of an input is detected. An order is submitted based on a combination of inputs.

### CROSS-REFERENCE TO RELATED APPLICATIONS

This application is a continuation of U.S. patent application Ser. No. 15/867,325 filed Jan. 10, 2018, which claims the benefit of U.S. Provisional Application No. 62/444,711 filed Jan. 10, 2017, each of which are incorporated by reference herein in their entireties.

### BACKGROUND

Advances in computing and networking technology allow electronic trades to be received and executed in fractions of a second. Computing devices may generate trades that move in and out of short term positions at high volumes and high speeds to exploit small price changes.

### BRIEF DESCRIPTION OF THE DRAWINGS

FIG. 1 is an example apparatus in accordance with aspects of the present disclosure.

FIG. 2 is an example network in accordance with aspects of the present disclosure.

FIG. 3 is a flow diagram of an example method in accordance with aspects of the present disclosure.

FIG. 4 is a working example in accordance with aspects of the present disclosure.

FIG. 5 is a flow diagram of a further example method in accordance with aspects of the present disclosure.

FIG. 6 is a further working example in accordance with aspects of the present disclosure.

### SUMMARY

As noted above, modern networked computers may execute trades at unprecedented speeds. Unfortunately, the rapid price changes that occur due to network velocity make it difficult for traders to capture a desired price. That is, when a trader attempts to enter an order at a particular price, the price moves rapidly before the order is entered. In turn, trades may be executed at prices that are not intended. The problem of elusive prices specifically arises in the realm of computer networking technology, since the speed of modern networks poses these new challenges by making market prices considerably volatile.

In view of the foregoing, disclosed herein are solutions rooted in computer technology that significantly reduce the time it takes to enter an order via a graphical user interface (“GUI”). In turn, the apparatus, method, and non-transitory computer readable medium disclosed herein permit orders to be filled at or near a desired price. In one example, an apparatus comprising a display screen, a network interface, an input device, and at least one processor is disclosed. In a further example, the at least one processor may carry out the following operations: render on the display screen a graphical user interface having a plurality of rows, each row having a product field, a bid field, and an offer field; detect via the input device a selection of a bid field or an offer field at a row of the plurality of rows; determine whether the selection is continuously maintained for a period of time; detect a release of the selection of the bid field or the offer field; and in response to the release of the selection after the selection was continuously maintained for the period of time, transmit, via the network interface, an order for a product specified in the product field of the row at a price specified in the bid field or the offer field of the row.

In a further aspect, disclosed herein is a method that includes the following operations by at least one processor: rendering on a display screen a graphical user interface having a plurality of rows, each row having a product field, a bid field, and an offer field; detecting a selection of a bid field or an offer field at a row of the plurality of rows via an input device; determining whether the selection is continuously maintained for a period of time; detecting a release of the selection of the bid field or the offer field; and in response to releasing the selection after the selection was continuously maintained for the period of time, transmitting an order, via a network interface, for a product specified in the product field of the row at a price specified in the bid field or the offer field of the row.

In yet a further example, an apparatus may include a display screen, a network interface, an input device, a memory, and at least one processor. The at least one processor may execute the following operations: render on the display screen a graphical user interface having a plurality of rows, each row having a product field, a bid field, and an offer field, each row being associated with an order; detect actuation of a first input on the input device; in response to detecting actuation of the first input, render on the display screen a target icon; detect a movement of the target icon over a bid field or offer field of a row of the plurality of rows; while the first input is continuously actuated and while the target icon hovers over the bid field or the offer field of the row: detect actuation of a second input on the input device; in response to actuation of the second input, change a status indicator in the memory to indicate that an order associated with the row is ready for trading; detect actuation of a third input on the input device; and in response to actuation of the third input, transmit, via the network interface, an order for a product specified in the product field of the row at a price specified in the bid field or the offer field on which the target icon hovers.

The aspects, features and advantages of the present disclosure will be appreciated when considered with reference to the following description of examples and accompanying figures. The following description does not limit the application; rather, the scope of the disclosure is defined by the appended claims and equivalents.

### DETAILED DESCRIPTION

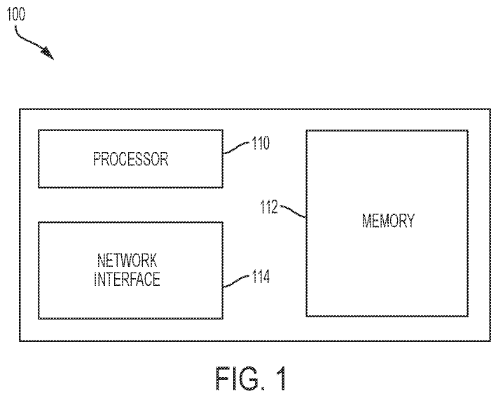

FIG. 1 presents a schematic diagram of an illustrative computer apparatus 100 for executing the techniques disclosed herein. Computer apparatus 100 may comprise any device capable of processing instructions and transmitting data to and from other computers, including a laptop, a full-sized personal computer, a high-end server, or a network computer lacking local storage capability. Computer apparatus 100 may include a keyboard and mouse and/or various other types of input devices such as pen-inputs, joysticks, buttons, touch screens, etc., as well as a display device, which could include, for instance, a CRT, LCD, plasma screen monitor, TV, projector, etc. Computer apparatus 100 may also comprise a network interface 114 to communicate with other devices over a network. Although all the components of computer apparatus 100 are functionally illustrated as being within the same block, it will be understood that the components may or may not be stored within the same physical housing.

The computer apparatus 100 may also contain at least one processor 110, which may include, but is not limited to, central processing units (CPUs), microcontrollers, digital signal processors, application specific integrated circuits (“ASICS”), or any combination thereof. A processor may include an Intel® Pentium®, Centrino®, and/or Core® processor. Processor 110 may receive instructions (e.g., from memory device 112 or like device), and execute those instructions, thereby performing one or more processes defined by those instructions.

As noted above, memory device 112 may store instructions that may be retrieved and executed by processor 110. Memory device 112 may include, but is not limited to, non-volatile media, volatile media, and non-transitory computer readable media (“CRM”). Non-volatile media include, for example, optical or magnetic disks, read-only memory (“ROM”), and other persistent memory. Volatile media include dynamic random access memory, which may constitute the main memory of computer apparatus 100. Memory device 112 may also include any combination of one or more of the foregoing and/or other devices as well. While only one processor 110 and one memory device 112 are shown in FIG. 1, it is understood that computer apparatus 100 may actually comprise additional processors and memories that may or may not be stored within the same physical housing or location.

A non-transitory CRM may comprise any one of many physical media such as, for example, electronic, magnetic, optical, electromagnetic, or semiconductor media. More specific examples of suitable non-transitory CRM include, but are not limited to, a portable magnetic computer diskette such as floppy diskettes or hard drives, an erasable programmable read-only memory, a portable compact disc, a flash drive, or other storage devices that may be coupled to computer apparatus 100 directly or indirectly.

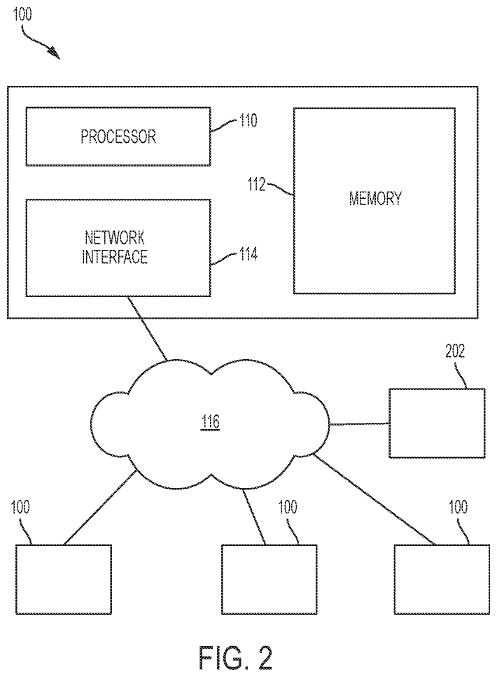

Turning now to FIG. 2, computer apparatus 100 is shown interconnected to other computer apparatus 100 via network interface 114 and network 116. Network 116 may be a local area network (“LAN”), wide area network (“WAN”), the Internet, etc. Network 116 and the intervening nodes thereof may use various protocols including virtual private networks, local Ethernet networks, and private networks using communication protocols proprietary to one or more companies, cellular and wireless networks, HTTP, and various combinations of the foregoing. Although only a few computers are depicted in the network of FIG. 2, it should be appreciated that a network may include additional interconnected computers and that the five computers shown in FIG. 2 are for ease of illustration. Each computer apparatus depicted in FIG. 2 may be an individual node in network 116. In this particular example, each computer apparatus 100 may be a client computer and computer apparatus 202 may be a server computer. The graphical user interfaces discussed below may be rendered on a given computer apparatus 100. In a further example, network 116 may form an electronic marketplace and computer apparatus 202 may monitor electronic trades entered at each computer apparatus 100 and match buy and sell orders entered at each computer apparatus 100. The network shown in FIG. 2 may be employed to trade any type of product including, but not limited to, financial products.

The instructions residing in memory device 112 may comprise any set of instructions to be executed directly (such as machine code) or indirectly (such as scripts) by processor 110. In this regard, the terms “instructions,” “scripts,” or “modules” may be used interchangeably herein. The computer executable instructions may be stored in any computer language or format, such as in object code or modules of source code. The instructions may be written in various programming languages, including an object-oriented programming language, such as SmallTalk, Java, C++, Ada, Python, or C# (C-Sharp), functional programming languages, scripting programming languages such as JavaScript, and/or logical programming languages. Furthermore, it is understood that the instructions may be implemented in the form of hardware, software, or a combination of hardware and software and that the examples herein are merely illustrative.

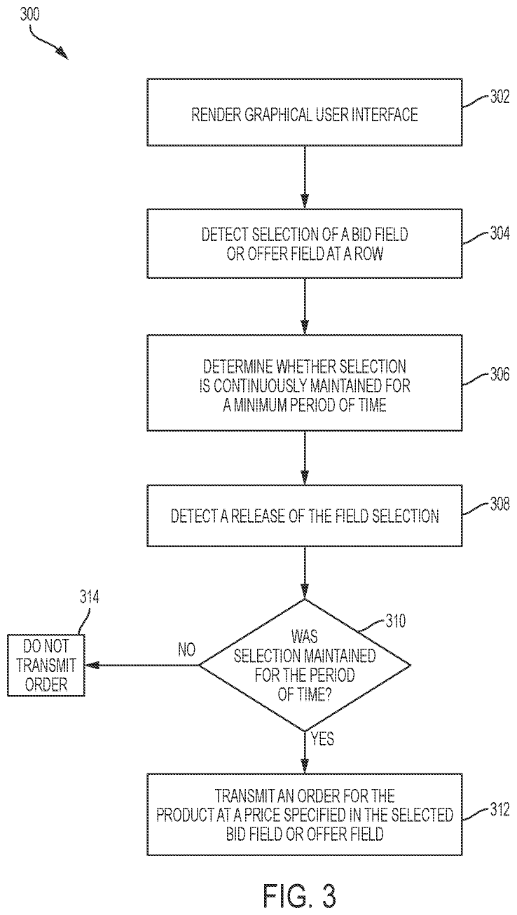

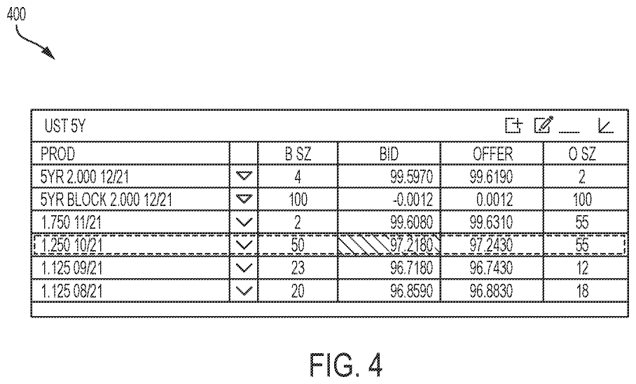

One example of the technological improvements disclosed herein is shown in FIGS. 3-4. In particular, FIG. 3 illustrates a flow diagram of an example method 300 for submitting an order using an improved GUI and FIG. 4 shows a corresponding working example. The actions shown in FIG. 4 will be discussed below with regard to the flow diagrams of FIG. 3.

In the example method 300 of FIG. 3, at block 302, processor 110 of computer apparatus 100 may render a GUI. FIG. 4 illustrates an example GUI trading screen 400 that may be displayed by computer apparatus 100. The example GUI trading screen 400 is depicted with the following columns or fields: product, bid size, bid price, offer price, and offer size. The example GUI trading screen 400 is also shown with six rows of data. Each row may contain market data for a particular financial product. Referring back to FIG. 3, processor 110 may detect a selection of a bid field or an offer field at a given row of the plurality of rows, as shown in block 304. In the example of FIG. 4, the bid field of the fourth row, showing a bid price of 97.2180, is selected. Selection of this bid price may result in the particular field or cell being highlighted, as illustrated in FIG. 4.

Referring back to FIG. 3, at block 306, processor 110 may determine whether the selection of the cell or field is continuously maintained for a minimum period of time. This period of time may be configurable and may be stored in memory device 112. In one example, processor 110 may alter the period of time in accordance with a user's selection. Processor 110 may generate a status indicator for each product represented by the rows in the GUI and store the status indicators in memory device 112. That is, processor 110 may generate an association between each status indicator and each row in the GUI and store these associations in a table in memory device 112. A given status indicator may be changed to indicate that a product is ready to trade, when the selection of the corresponding row is maintained for the predetermined period of time (e.g., half a second).

Referring back to FIG. 3, at block 308, processor 110 may detect that the selection of the field was released. At block 310, processor 110 may determine if the selection of the cell or field was maintained for the minimum period of time mentioned above before it was released. Processor 110 may detect that the continuous hold of the mouse button or continuous touch of a touch screen has been released while the cell or field is highlighted. If the selection was released after the selection was maintained for the period of time, at block 312, processor 110 may transmit an order for the product specified in the product field at or near a price specified in the selected bid field or ask field of the row. If the selection is released before the period of time was reached, at block 314, processor 110 does not transmit the order. In a further example, processor 110 may require the release to occur while the cursor is in the field before transmitting the order.

Allowing a trade to be submitted to the network upon release of a held price field selection significantly reduces the time it takes to enter an order. The trade may be submitted with all the other non-price information automatically populated. For example, the order may be submitted with a default size and order type (e.g., LIMIT, FILL OR KILL, etc.). The other non-price order parameters may be preconfigured by a user before trading. This is an improvement over conventional computer technology that requires a trader to manually populate all the required fields at the time of order entry. Holding the selection also allows a user to visually monitor the price fluctuations and release the selection when a desired price appears on the price field.

In some situations, allowing orders to be submitted too quickly may lead to inadvertent order submissions. In this instance, a trade may be submitted unintentionally and result in a significant financial loss. However, excessive precaution for order entry may slow down the process. As such, in another aspect of the present disclosure, an apparatus, method, and non-transitory computer readable medium permits an order to be submitted with precautionary measures without unduly restricting order entry.

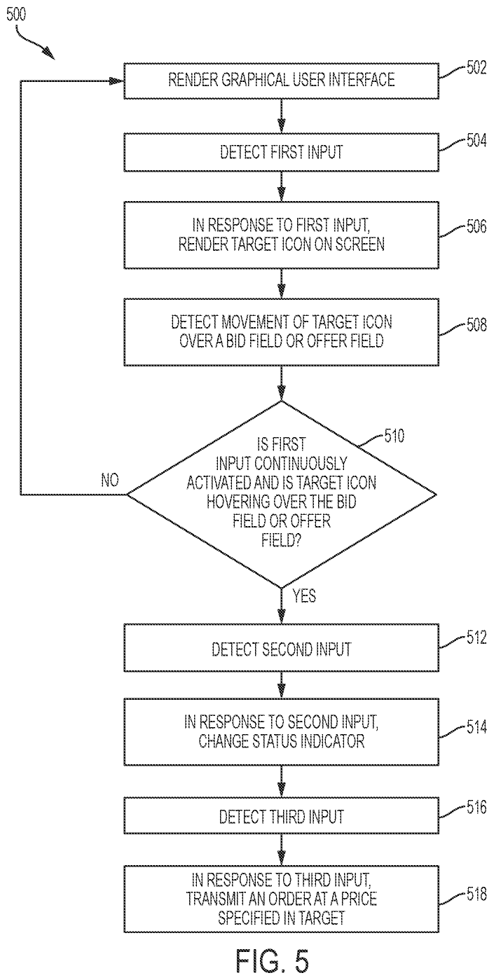

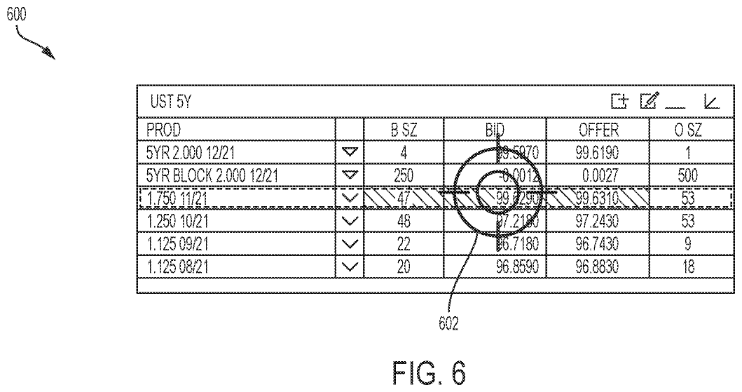

An example of this balanced approach is shown in FIGS. 5-6. FIG. 5 illustrates a flow diagram of an example method 500 for submitting an order with a target icon and additional safety features and FIG. 6 shows a working example thereof. The actions shown in FIG. 6 will be discussed below with regard to the flow diagram of FIG. 5.

Referring to FIG. 5, at block 502, processor 110 may render a GUI on a display screen. As with the previous example, FIG. 6 shows a further example GUI trading screen 600 with a plurality of rows representative of products. Each row has a product field, bid size field, bid field, offer size field, and offer price field. Referring back to FIG. 5, processor 110 may detect the actuation of a first input at block 504, which may include the actuation of a keyboard button (e.g., the CTRL button), clicking a mouse button, a touch on a touch screen, or the like. In response to the first input, processor 110 may render a target or bullseye icon on the display screen, as shown in block 506. In another example, the bullseye or target icon may be rendered when the first input is held for the minimum time (e.g., half a second). As with the pervious example of FIGS. 3-4, this time may also be configurable. At block 508, processor 110 may detect a movement of the target icon over a bid field or offer field at one of the rows on the GUI. FIG. 6 depicts an example target icon 602 targeting a particular bid field on the third row of the GUI trading screen 600. While the target icon 602 hovers over the bid field, processor 110 may highlight the particular cell or the entire row.

Referring again to FIG. 5, at block 510, processor 110 may determine whether the first input is continuously actuated while the target icon continuously hovers over the bid field or offer field. If not, processor 110 just continuously renders the GUI at block 502. While the first input is continuously actuated and while the target icon continuously hovers over the bid field or offer field, processor 110 may execute blocks 512 through 518. At block 512, processor 110 may detect actuation of a second input. Such second input (e.g., a mouse down click or a touch on a touch screen) may cause a change in the state of the product in memory device 112 to indicate that the product is ready to trade, as shown in block 514. At block 516, processor 110 may detect a third input. The third input may be, for example, a mouse up click or a second touch of the touch screen. At block 518, in response to detecting actuation of the third input, while the target icon hovers over the price cell and while the first input (e.g., CTRL key) is continuously actuated, processor 110 may submit a trade to the network at or near the price shown in the price cell within the target icon.

In a further example, if the first input is interrupted before the second or third inputs are detected, processor 110 may remove the “ready to trade” state from memory device 112. This may prevent an order from being submitted until the input sequence is detected. By keeping the first input actuated while the icon targets the desired price, and by waiting to detect the second and third inputs, the example of FIGS. 5-6 makes an inadvertent order entry less likely. At the same time, the example of FIGS. 5-6 does not unduly impede the order entry process.

Advantageously, the above-described apparatus, non-transitory computer readable medium, and method allow trades to be entered at or near a desired price notwithstanding rapid price changes due to networking and computer speed. Furthermore, the disclosed techniques also include certain precautionary operations that reduce the likelihood of an accidental order entry without overly delaying the order entry process. Accordingly, the present disclosure illustrates solutions to a problem in the software arts that arises in the realm of computer networking. The disclosed GUI solutions improve the functioning of technology by improving the accuracy of trader transactions.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure.

1. An apparatus comprising:
a display screen;
a network interface;
an input device;
at least one processor to:
render on the display screen a graphical user interface having a plurality of rows, each row having a product field, a bid field, and an offer field;
detect via the input device a selection of a bid field or an offer field at a row of the plurality of rows;
determine whether the selection is continuously maintained for a period of time;
detect a release of the selection of the bid field or the offer field; and
in response to the release of the selection after the selection was continuously maintained for the period of time, transmit, via the network interface, an order for a product specified in the product field of the row at a price specified in the bid field or the offer field of the row.
